(19) United States
(12) Patent Application Publication
(10) Pub. No.: US 2024/0196300 A1
(43) Pub. Date: Jun. 13, 2024

(54) PRIMARY LINK OPERATION WITH SINGLE RADIO MULTI-LINK DEVICE OR NON-SIMULTANEOUS TRANSMIT AND RECEIVE ACCESS POINT MULTI-LINK DEVICE

(71) Applicant: NXP USA, Inc., Austin, TX (US)

(72) Inventors: Liwen CHU, San Ramon, CA (US); Kiseon RYU, San Diego, CA (US); Huizhao WANG, San Jose, CA (US); Hongyuan ZHANG, Fremont, CA (US)

(21) Appl. No.: 18/538,596

(22) Filed: Dec. 13, 2023

Related U.S. Application Data
(60) Provisional application No. 63/387,114, filed on Dec. 13, 2022.
(60) Provisional application No. 63/476,159, filed on Dec. 19, 2022.
(60) Provisional application No. 63/476,238, filed on Dec. 20, 2022.

(51) Int. Cl. H04W 40/02; H04W 76/15

(52) U.S. Cl. CPC H04W 40/02; H04W 76/15

(57) ABSTRACT

A method and system of exchanging frames between a first multi-link device (MLD) and a second MLD, including: announcing, by the first MLD, a set of links with the second MLD, wherein the set of links includes a primary link and a non-primary link and wherein a single full function radio in the first MLD switches between the primary link and the non-primary link; switching, by the first MLD and second MLD, to the non-primary link when the primary link is busy; exchanging frames between the first MLD and the second MLD; and switching back to the primary link, by the first MLD and the second MLD, when a transmit opportunity (TXOP) of the primary link ends.

### CROSS-REFERENCE TO RELATED APPLICATIONS

This application claims the benefit of U.S. Provisional Patent Application No. 63/387,114, filed Dec. 13, 2022, U.S. Provisional Patent Application No. 63/476,159, filed Dec. 19, 2022, and U.S. Provisional Patent Application No. 63/476,238, filed Dec. 20, 2022, the contents each of which are incorporated for all purposes by reference herein in its entirety.

### FIELD OF THE DISCLOSURE

Various exemplary embodiments disclosed herein relate to primary link operation with single radio multi-link device (MLD) or non-simultaneous transmit and receive (NSTR) access point (AP) MLD.

### BACKGROUND

When multi-link operation (MLO) is used with MLDs, certain links are designated as primary links. The primary link is used with beacon messages and association protocols to set up transmit opportunities (TXOPs) for data transmission between an AP MLD and a non-AP MLD.

### SUMMARY

A summary of various exemplary embodiments is presented below.

Various embodiments relate to a method of exchanging frames between a first multi-link device (MLD) and a second MLD, including: announcing, by the first MLD, a set of links with the second MLD, wherein the set of links includes a primary link and a non-primary link and wherein a single full function radio in the first MLD switches between the primary link and the non-primary link; switching, by the first MLD and second MLD, to the non-primary link when the primary link is busy; exchanging frames between the first MLD and the second MLD; and
switching back to the primary link, by the first MLD and the second MLD, when a transmit opportunity (TXOP) of the primary link ends.

Various embodiments are described, wherein the first MLD is multi-link single radio (MLSR) AP MLD and the second MLD is one of a MLSR MLD, enhanced MLSR (EMLSR) MLD, a simultaneous transmit and receive (STR) multi-link multiple radio (MLMR), and a non-STR (NSTR) MLMR non-AP MLD.

Various embodiments are described, wherein the first MLD includes a low cost radio to monitor one link when doing frame exchanges in another link.

Various embodiments are described, wherein the first MLD is a non-simultaneous transmit and receive (NSTR) multi-link multiple radio (MLMR) AP MLD and the second MLD is one of a multi-link single radio (MLSR) MLD, enhanced MLSR (EMLSR) MLD, a simultaneous transmit and receive (STR) MLMR, and a non-STR (NSTR) MLMR non-AP MLD.

Various embodiments are described, wherein the first MLD is an enhanced multi-link single radio (EMLSR) AP MLD and the second MLD is one of a MLSR MLD, enhanced MLSR (EMLSR) MLD, a simultaneous transmit and receive (STR) multi-link multiple radio (MLMR), and a non-STR (NSTR) MLMR non-AP MLD.

Various embodiments are described, wherein the set of links is an EMLSR link set.

Various embodiments are described, wherein the first MLD switches to monitor multiple links when a frame exchange failure is detected or when the first MLD receives a frame not addressed to the first MLD.

Various embodiments are described, wherein the first MLD stays in the non-primary link when a frame exchange failure is detected or when the first MLD receives a frame not addressed to the first MLD.

Various embodiments are described, wherein the first MLD and the second MLD are multi-link tunneled direct-link setup (TDLS) peer multi-link single radio (MLSR) non-AP MLDs.

Further various embodiments relate to a first multi-link device (MLD) for communicating with a second MLD, including a processor configured to: announce a set of links with the second MLD, wherein the set of links includes a primary link and a non-primary link and wherein a single full function radio in the first MLD switches between the primary link and the non-primary link; switching to the non-primary link when the primary link is busy; exchanging frames between the first MLD and the second MLD; and switching back to the primary link, by the first MLD when a transmit opportunity (TXOP) of the primary link ends.

Various embodiments are described, wherein the first MLD is multi-link single radio (MLSR) AP MLD and the second MLD is one of a MLSR MLD, enhanced MLSR (EMLSR) MLD, a simultaneous transmit and receive (STR) multi-link multiple radio (MLMR), and a non-STR (NSTR) MLMR non-AP MLD.

Various embodiments are described, wherein the first MLD includes a low cost radio to monitor one link when doing frame exchanges in another link.

Various embodiments are described, wherein the first MLD is a non-simultaneous transmit and receive (NSTR) multi-link multiple radio (MLMR) AP MLD and the second MLD is one of a multi-link single radio (MLSR) MLD, enhanced MLSR (EMLSR) MLD, a simultaneous transmit and receive (STR) MLMR, and a non-STR (NSTR) MLMR non-AP MLD.

Various embodiments are described, wherein the first MLD is an enhanced multi-link single radio (EMLSR) AP MLD and the second MLD is one of a MLSR MLD, enhanced MLSR (EMLSR) MLD, a simultaneous transmit and receive (STR) multi-link multiple radio (MLMR), and a non-STR (NSTR) MLMR non-AP MLD.

Various embodiments are described, wherein the set of links is an EMLSR link set.

Various embodiments are described, wherein the first MLD switches to monitor multiple links when a frame exchange failure is detected or when the first MLD receives a frame not addressed to the first MLD.

Various embodiments are described, wherein the first MLD stays in the non-primary link when a frame exchange failure is detected or when the first MLD receives a frame not addressed to the first MLD.

Various embodiments are described, wherein the first MLD and the second MLD are multi-link tunneled direct-link setup (TDLS) peer multi-link single radio (MLSR) non-AP MLDs.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts a multi-link communications system 10 that is used for a wireless network.

FIG. 2 illustrates a system with an EMLSR non-AP MLD and a MLSR non-AP MLD.

FIG. 3 illustrates a system with two MLSR non-AP MLDs.

FIG. 4 illustrates a system with an EMLSR AP MLD and two EMLSR non-AP MLDs.

FIG. 5 illustrates a system with an EMLSR AP MLD and a NSTR non-AP MLD and STR non-AP MLD.

FIG. 6 illustrates a system with a MLSR AP MLD and a NSTR non-AP MLD and MLSR non-AP MLD.

FIG. 7 illustrates a system with a STR AP MLD and a MLSR non-AP MLD.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of wireless networks with primary link operation with single radio MLD or NSTR AP MLD systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

Several aspects of WiFi systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

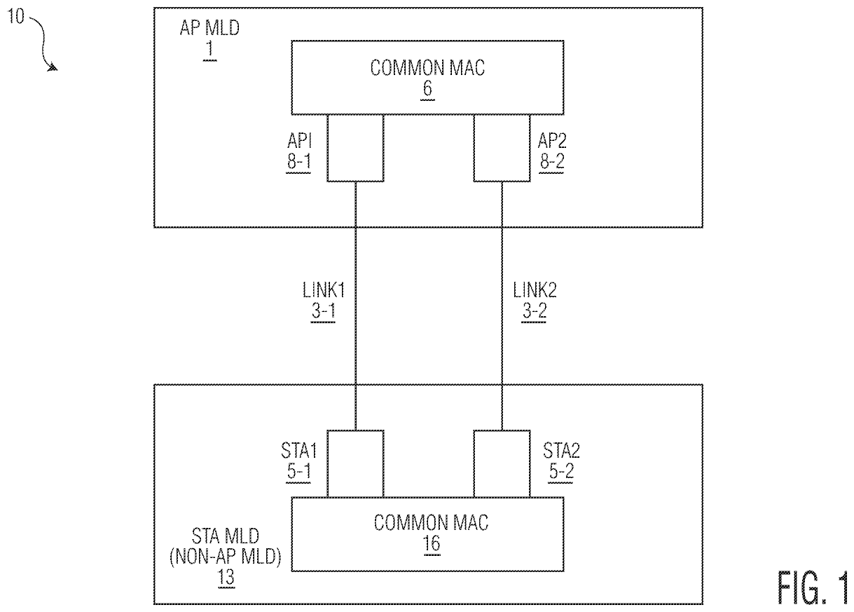

FIG. 1 depicts a multi-link communications system 10 that is used for wireless (e.g., WiFi) communications. In the embodiment depicted in FIG. 1, the multi-link communications system includes one AP multi-link device, which is implemented as AP MLD 1, and one non-AP STA multi-link device, which is implemented as STA MLD (non-AP MLD) 13. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Various iterations of the 802.11 specification are referred to herein. IEEE 802.11ac is referred to as very high throughput (VHT). IEEE 802.11ax is referred to as high efficiency (HE). IEEE 802.11be is referred to as extreme high throughput (EHT). IEEE 802.11bn is referred to as ultra-high reliability (UHR). The terms VHT, HE, EHT, and UHR will be used in the descriptions found herein.

Although the depicted multi-link communications system 10 is shown in FIG. 1 with certain components and described with certain functionality herein, other embodiments of the multi-link communications system may include fewer or more components to implement the same, less, or more functionality. For example, in some embodiments, the multi-link communications system includes a single AP MLD and multiple associated STA MLDs, or multiple AP MLDs and multiple STA MLDs with each STA MLD being associated with an AP MLD. In some embodiments, the legacy STAs (non-HE STAs) associate with one of the APs affiliated with the AP MLD. In some embodiment an AP MLD may have a single affiliated AP. In some embodiment a STA MLD may have a single affiliated STA. In another example, although the multi-link communications system is shown in FIG. 1 as being connected in a certain topology, the network topology of the multi-link communications system is not limited to the topology shown in FIG. 1.

In the embodiment depicted in FIG. 1, the AP MLD 1 includes a common MAC 6 and two APs 8-1, 8-2 in two links. In such an embodiment, the APs may be AP1 8-1 and AP2 8-2. In some embodiments, a common MAC 6 of the AP MLD 1 implements upper layer Media Access Control (MAC) functionalities (e.g., association establishment, reordering of frames, etc.) and a link specific part of the AP MLD 1, i.e., the APs 8-1 and 8-2, implement lower layer MAC functionalities (e.g., backoff, frame transmission, frame reception, etc.), PHY layer functionalities, radios. The APs 8-1 and 8-2 may be implemented in hardware (e.g., circuits), software, firmware, or a combination thereof. The APs 8-1 and 8-2 may be fully or partially implemented as an integrated circuit (IC) device. In some embodiments, the APs 8-1 and 8-2 may be wireless APs compatible with at least one WLAN communications protocol (e.g., at least one IEEE 802.11 protocol). For example, the APs 8-1 and 8-2 may be wireless APs compatible with the IEEE 802.11bn protocol.

In some embodiments, an AP MLD (e.g., AP MLD 1) connects to a local area network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiment, an AP (e.g., AP1 8-1 and/or AP2 8-2) includes multiple RF chains. In some embodiments, an AP (e.g., AP1 8-1 and/or AP2 8-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 8-1 or 8-2 of the AP MLD 1 with multiple RF chains may operate in a different basic service set (BSS) operating channel (in a different link). For example, AP1 8-1 may operate in a 320 MHz BSS operating channel at 6 GHz band, and AP2 8-2 may operate in a 160 MHz BSS operating channel at 5 GHZ band. Although the AP MLD 1 is shown in FIG. 1 as including two APs, other embodiments of the AP MLD 204 may include more than two APs, or one AP only.

In the embodiment depicted in FIG. 1, the non-AP STA multi-link device, implemented as STA MLD 13, includes a common MAC 16, two non-AP STAs 5-1 and 5-2 in two links. In such an embodiment, the non-AP STAs may be STA1 5-1 and STA2 5-2. The STAs 5-1 and 5-2 may be implemented in hardware (e.g., circuits), software, firmware, or a combination thereof. The STAs 5-1 and 5-2 may be fully or partially implemented as an IC device. In some embodiments, the non-AP STAs 5-1 and 5-2 are part of the STA MLD 13, such that the STA MLD may be a communications device that wirelessly connects to a wireless AP MLD. For example, the STA MLD 13 may be implemented in a laptop, a desktop personal computer (PC), a mobile phone, or other communications device that supports at least one WLAN communications protocol. In some embodiments, the non-AP STA MLD 13 is a communications device compatible with at least one IEEE 802.11 protocol (e.g., an IEEE 802.11bn protocol, an IEEE 802.11be protocol, an IEEE 802.11ax protocol, or an IEEE 802.11ac protocol). In some embodiments, the STA MLD 13 implements a common MAC functionality 16 and the non-AP STAs 5-1 and 5-2 implement a lower layer MAC data functionality, PHY functionalities.

In some embodiments, the AP MLD 1 and/or the STA MLD 13 may identify which communication links support multi-link operation during a multi-link operation setup phase and/or exchanges information regarding multi-link capabilities during the multi-link operation setup phase. In some embodiments, each of the non-AP STAs 5-1 and 5-2 of the STA MLD 13 in different link may operate in a different frequency band. For example, the non-AP STA1 5-1 in one link may operate in the 2.4 GHz frequency band and the non-AP STA2 5-2 in another link may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 1, the STA MLD 13 communicates with the AP MLD 1 via two communication links, e.g., link 1 3-1 and link 2 3-2. For example, each of the non-AP STAs 3-1 or 3-2 communicates with an AP 8-1 or 8-2 via corresponding communication links 3-1 or 3-2. In an embodiment, a communication link (e.g., link 1 3-1 or link 2 3-2) may include a BSS operating channel established by an AP (e.g., AP1 8-1 or AP2 8-2) that features multiple 20 MHz channels used to transmit frames (e.g., Beacon frames, management frames, etc.) being carried in Physical Layer Convergence Protocol (PLCP) Protocol Data Units (PPDUs) between a first wireless device (e.g., an AP, an AP MLD, an STA, or an STA MLD) and a second wireless device (e.g., an AP, an AP MLD, an STA, or an STA MLD). In some embodiments, a 20 MHz channel may be a punctured 20 MHz channel or an unpunctured 20 MHz channel. Although the STA MLD 13 is shown in FIG. 1 as including two non-AP STAs, other embodiments of the STA MLD 13 may include one non-AP STA or more than two non-AP STAs. In addition, although the AP MLD 1 communicates (e.g., wirelessly communicates) with the STA MLD 13 via multiple links 3-1 and 3-2, in other embodiments, the AP MLD 1 may communicate (e.g., wirelessly communicate) with the STA MLD 13 via more than two communication links or less than two communication links.

As described above a multi-link AP MLD has one or multiple links where each link has one AP affiliated with the AP MLD. This may be accomplished by having the different radios for the different affiliated APs.

A multi-link STA MLD has one or multiple links where each link has one STA affiliated with the STA MLD. One way to implement the multi-link STA MLD is using two or more radios, where each radio is associated with a specific link. For example, an multi-link multi-radio (MLMR) non-AP MLD may be used. The MLMR non-AP MLD uses multiple full functional radios to monitor the medium in multiple links. Another way to implement the multi-link STA MLD is using a single radio in two different links. Each link may be associated with a specific band. In this case only one link is available at a time. In yet another implementation, an enhanced single-radio (ESR) STA MLD may be used that operates in an enhanced multi-link single radio (cMLSR) mode. The ESR STA MLD uses two radios in different links to implement the MLD. For example, one radio may be a lower cost radio with lesser capabilities and the other radio may be a fully functional radio supporting the frame exchanges with the high capacity. The ESR STA MLD may dynamically switch its working link while it can only transmit or receive through one link at any time. The ESR STA MLD may monitor two links simultaneously, for example, detecting medium idle/busy status of each link, or receiving a PPDU on each link. Each radio may have its own backoff time, and when the backoff counter for one of the radios becomes zero that radio and link may be used for transmission. For example, if an AP wants to use the fully functional radio, it may send a control frame that is long enough for the ESR STA MLD to switch from the lesser capable radio to the fully functional radio that may then transmit data to the AP. When an ESS includes multiple AP MLDs in different locations and a STA MLD executed the data frame exchanges with one of the AP MLDs (say AP MLD1), as the STA MLD's associated AP MLD moves to other location to do the data frame exchanges with another one of the AP MLDs (say AP MLD2), the STA MLD (same as a non-AP MLD herein) needs to finish the association with AP MLD2 before doing the data frame exchanges with AP MLD2. There is a requirement to decrease the number of associations within the ESS.

It has been proposed for an AP device is an EMLSR AP MLD that one EMLSR link of the AP MLD can be used to transmit Beacon frames. The other EMLSR links will not transmit Beacon frames.

In another proposal, the EMLSR link used for the Beacon transmission and association is a primary link. When the primary link is busy because of overlapping BSS's (OBSS's) TXOP, the EMLSR AP MLD and its associated multi-link non-AP MLDs may use a non-primary link (i.e., an EMLSR link that is not used for Beacon transmission, association) to do frame exchanges until the end of the OBSS's TXOP in primary link. As a result, the medium synchronization operation when switching back to the primary link from the non-primary link can be avoided.

Embodiments are disclosed herein that extend the primary link to the other cases including Multi-link TDLS with two MLSR peer non-AP MLDs, NSTR mobile AP MLDs, and frame exchanges between an EMLSR AP MLD and associated MLSR/NSTR/STR non-AP MLD.

For a NSTR AP MLD a primary link and non-primary link are defined. The mobile AP MLD can use the non-primary link for the frame exchange with a non-AP MLD only when the primary link is used for the frame exchanges with the non-AP MLD. When the backoff counters on both the primary link and non-primary link are zero, the primary link and non-primary link may be used for the frame exchanges.

A multi-radio non-AP MLD can use the non-primary link for the frame exchange with a NSTR mobile AP MLD only when the primary link is used for the frame exchanges with the mobile AP MLD. When the backoff counters on both primary link and non-primary link are zero, the primary link and non-primary link can be used for the frame exchanges.

This leads to issues with the current link usage rules because when the primary link is busy, the second link cannot be used although the second link is idle.

Various proposals will now be presented that allow for the use of non-primary links for data exchange.

A first proposal describes frame exchanges between non-AP MLD and mobile NSTR AP MLD. When the primary link is busy because of the TXOP of neighbor BSS/point-to-point (P2P), both the mobile AP MLD and its associated non-AP MLD can switch to the non-primary link to do the frame exchanges. The frame exchanges need to be finished before the end of the TXOP of neighbor BSS/P2P in the primary link.

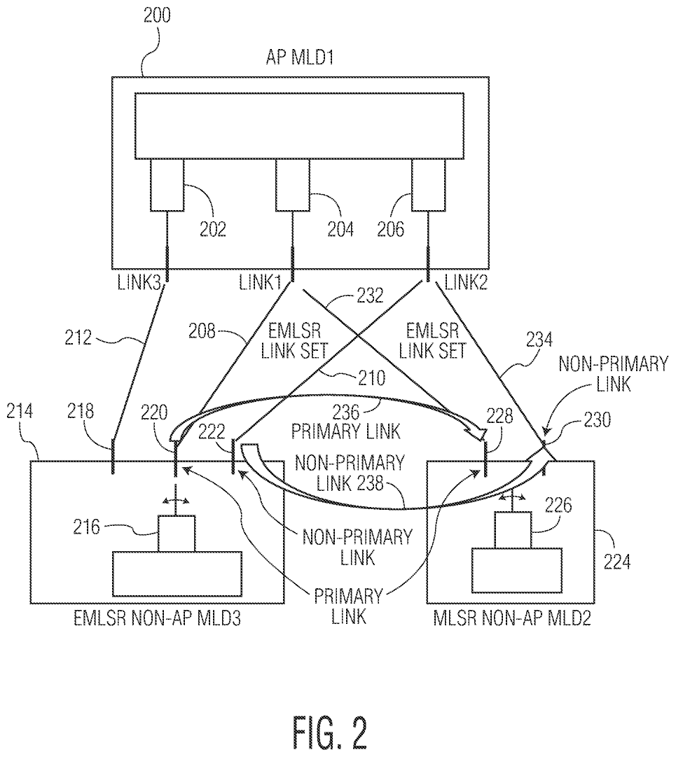

A second proposal describes frame exchanges between multi-link tunneled direct-link setup (TDLS) with two MLSR non-AP MLDs. The MLSR non-AP MLDs establish the multi-link TDLS where one link is the primary link and the other link(s) are non-primary link(s). FIG. 2 illustrates a system with an EMLSR non-AP MLD and a MLSR non-AP MLD. An AP MLD1 200 includes AP MLD1 first radio 202, AP MLD1 second radio 204, and AP MLD1 third radio 206 and their associated antennas. The AP MLD1 200 communicates with an EMLSR non-AP MLD3 214 and a MLSR non-AP MLD2 224. The AP MLD1 200 has first link 208, second link 210, and third link 212 with EMLSR non-AP MLD3 214. The first link 208 is a primary link, and the second link 210 is a secondary link. Likewise, the AP MLD1 200 has first link 232 and second link 234 with MLSR non-AP MLD2 224. The first link 232 is a primary link, and second link 234 is a secondary link.

The EMLSR non-AP MLD3 214 includes a EMLSR non-AP MLD3 radio 216. The EMLSR non-AP MLD3 radio 216 is connected to EMLSR non-AP MLD3 first antenna 218, EMLSR non-AP MLD3 second antenna 220, and EMLSR non-AP MLD3 third antenna 222. This allows for multi-link operation (MLO). Further, MLSR non-AP MLD2 224 includes MLSR non-AP MLD2 radio 226. The MLSR non-AP MLD2 radio 226 is connected to MLSR non-AP MLD2 first antenna 228 and MLSR non-AP MLD2 second antenna 230. This allows for MLO.

In P2P operation, there is a primary P2P link 236 and secondary P2P link 238 between the EMLSR non-AP MLD3 214 and the MLSR non-AP MLD2 224.

When the primary link (236) is idle, the primary link is used to do the frame exchanges between the TDLS peer non-AP MLDs (non-AP MLD 2 and non-AP MLD3). When the primary link is busy because of the TXOP of neighbor BSS/P2P, both the TDLS peer EMLSR non-AP MLD3 214 and TDLS peer MLSR non-AP MLD2 224 may use the non-primary link (238) to do the frame exchanges. The frame exchanges need to be finished before the end of the TXOP of the neighbor BSS/P2P.

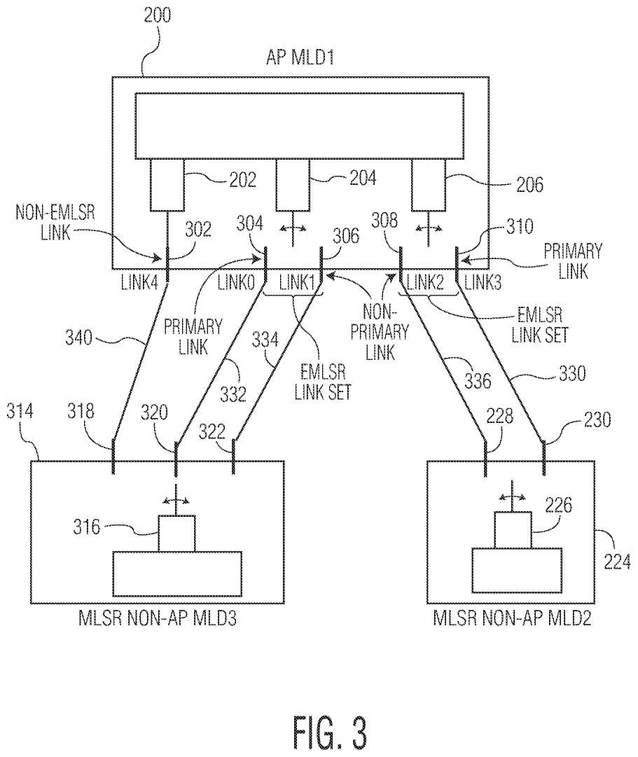

A third proposal describes frame exchanges between an EMLSR AP MLD and a MLSR non-AP MLD. FIG. 3 illustrates a system with two MLSR non-AP MLDs. An AP MLD1 200 includes AP MLD1 first radio 202, AP MLD1 second radio 204, and AP MLD1 third radio 206. In this case the AP MLD1 200 is an EMLSR AP MLD. The AP MLD1 first radio 202 is connected to AP MLD1 first antenna 302. The AP MLD1 second radio 204 is connected to AP MLD1 second antenna 304 and AP MLD1 third antenna 306. The AP MLD1 third radio 206 is connected to AP MLD1 fourth antenna 308 and AP MLD1 fifth antenna 310. The AP MLD1 200 communicates with a MLSR non-AP MLD3 314 and a MLSR non-AP MLD2 224. The AP MLD1 200 has a first link 332, second link 334, and fifth link 340 with MLSR non-AP MLD3 314. The first link 332 and second link 334 form a EMLSR link set. The first link 332 is a primary link, the second link 334 is a secondary link, and the fifth link 340 is a non-EMLSR link. Likewise, the AP MLD1 200 has third link 336 and fourth link 338 with MLSR non-AP MLD2 224. The fourth link 338 is a primary link, and third link 336 is a secondary link.

The MLSR non-AP MLD3 314 includes a MLSR non-AP MLD3 radio 316. The MLSR non-AP MLD3 radio 316 is connected to MLSR non-AP MLD3 first antenna 318, EMLSR non-AP MLD3 second antenna 320, and MLSR non-AP MLD3 third antenna 322. This allows for multi-link operation (MLO). Further, MLSR non-AP MLD2 224 includes MLSR non-AP MLD2 radio 226. The MLSR non-AP MLD2 radio 226 is connected to MLSR non-AP MLD2 first antenna 228 and MLSR non-AP MLD2 second antenna 230. This allows for MLO.

When the primary link is idle, the MLSR non-AP MLD3 314 (or 224) and AP MLD1 200 uses its primary link to do the frame exchanges. When the primary link is busy because of OBSS's TXOP, the EMLSR AP MLD 200 and MLSR non-AP MLD 314 (or 224) switch its radio to the non-primary link. The frame exchanges in a non-primary link ends at the end of the TXOP owned by the neighbor BSS in the primary link.

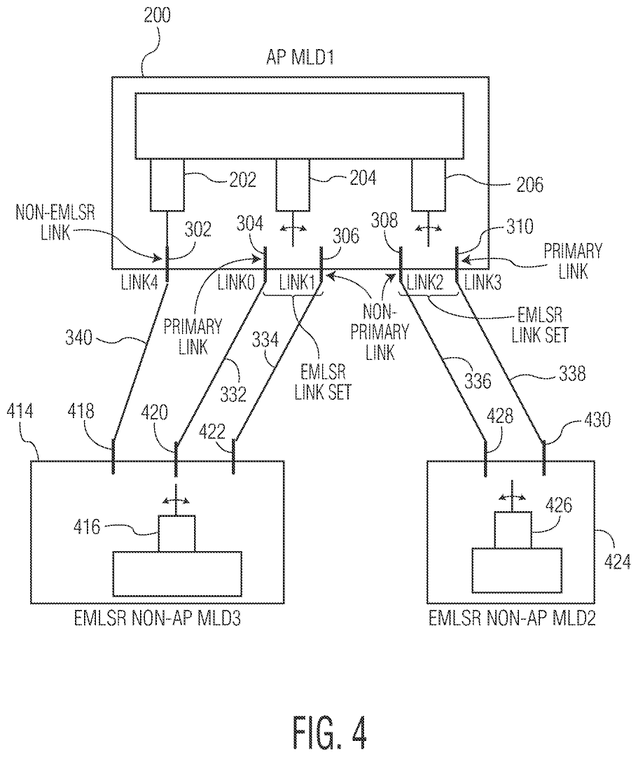

A fourth proposal describes frame exchanges between an EMLSR AP MLD and an EMLSR non-AP MLD. FIG. 4 illustrates a system with an EMLSR AP MLD and two EMLSR non-AP MLDs. An AP MLD1 200 includes AP MLD1 first radio 202, AP MLD1 second radio 204, and AP MLD1 third radio 206. In this case the AP MLD1 200 is an EMLSR AP MLD. The AP MLD1 first radio 202 is connected to AP MLD1 first antenna 302. The AP MLD1 second radio 204 is connected to AP MLD1 second antenna 304 and AP MLD1 third antenna 306. The AP MLD1 third radio 206 is connected to AP MLD1 fourth antenna 308 and AP MLD1 fifth antenna 310. The AP MLD1 200 communicates with an EMLSR non-AP MLD3 414 and an EMLSR non-AP MLD2 324. The AP MLD1 200 has a first link 332, second link 334, and fifth link 340 with EMLSR non-AP MLD3 414. The first link 332 and second link 334 form a EMLSR link set. The first link 332 is a primary link, the second link 334 is a secondary link, and the fifth link 340 is a non-EMLSR link. Likewise, the AP MLD1 200 has third link 336 and fourth link 338 with EMLSR non-AP MLD2 424. The fourth link 338 is a primary link, and third link 336 is a secondary link.

The EMLSR non-AP MLD3 414 includes an EMLSR non-AP MLD3 radio 416. The EMLSR non-AP MLD3 radio 416 is connected to EMLSR non-AP MLD3 first antenna 418, EMLSR non-AP MLD3 second antenna 420, and EMLSR non-AP MLD3 third antenna 422. This allows for multi-link operation (MLO). Further, EMLSR non-AP MLD2 424 includes EMLSR non-AP MLD2 radio 426. The EMLSR non-AP MLD2 radio 426 is connected to EMLSR non-AP MLD2 first antenna 428 and EMLSR non-AP MLD2 second antenna 430. This allows for MLO.

When the primary link is idle, the EMLSR non-AP MLD and EMLSR AP MLD uses its primary link to do the frame exchanges. When the primary link is busy because of the OBSS's TXOP, the EMLSR AP MLD and EMLSR non-AP MLD switch its radio to the non-primary link. The frame exchanges in a non-primary link needs more discussion.

A first option for EMLSR non-AP MLD behavior is that within a TXOP in a non-primary link initiated by the AP MLD with a EMLSR non-AP MLD as the TXOP responder, the EMLSR non-AP MLD switches to monitor multiple links when it detects a frame exchange failure or a frame/PPDU that is not addressed to it.

A second option for EMLSR non-AP MLD behavior is that within a TXOP in a non-primary link initiated by the AP MLD with a EMLSR non-AP MLD as the TXOP responder, the EMLSR non-AP MLD stays in non-primary link, when it detects a frame exchange failure or a frame/PPDU that is not addressed to it and the primary link is still busy (per the virtual carrier sensing in primary link).

A third option for EMLSR non-AP MLD behavior is that when all the setup links of an EMLSR non-AP MLD that are capable doing EMLSR frame exchanges are covered by one EMLSR link set of the associated AP MLD, the EMLSR non-AP MLD is not allowed to be in EMLSR mode. Otherwise, an EMLSR non-AP MLD can be in EMLSR mode.

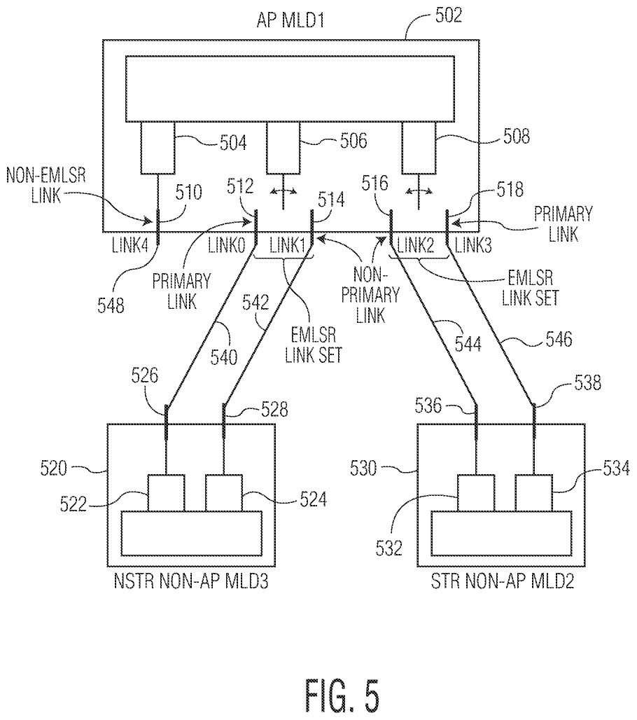

A fifth proposal describes frame exchanges between EMLSR AP MLD and STR/NSTR non-AP MLD. FIG. 5 illustrates a system with an EMLSR AP MLD and a NSTR non-AP MLD and STR non-AP MLD. The EMSLR AP MLD1 502 includes EMSLR AP MLD1 first radio 504, EMSLR AP MLD1 second radio 506, and EMSLR AP MLD1 third radio 508. The EMSLR AP MLD1 first radio 504 is connected to EMSLR AP MLD1 first antenna 510. The EMSLR AP MLD1 second radio 506 is connected to EMSLR AP MLD1 second antenna 512 and EMSLR AP MLD1 third antenna 514. The EMSLR AP MLD1 third radio 508 is connected to EMSLR AP MLD1 fourth antenna 516 and EMSLR AP MLD1 fifth antenna 518. The EMSLR AP MLD1 502 communicates with NSTR non-AP MLD3 520 and STR non-AP MLD2 530. The EMSLR AP MLD1 502 has a fifth link 548 that is a non-EMLSR link. The EMSLR AP MLD1 502 has a first link 540 and second link 542 with the NSTR non-AP MLD3 520. The EMSLR AP MLD1 second antenna 512 and EMSLR AP MLD1 third antenna 514 form an EMLSR link set. The EMSLR AP MLD1 502 has third link 544 and fourth link 546 with STR non-AP MLD2 first radio 532. The third link 544 and fourth link 546 form an EMLSR link set. The first link 540 and fourth link 546 are primary links. The second link 542 and third link 544 are secondary links.

The NSTR non-AP MLD3 520 includes a NSTR non-AP MLD3 first radio 522 and NSTR non-AP MLD3 second radio 524. The NSTR non-AP MLD3 first radio 522 is connected to NSTR non-AP MLD3 first antenna 526. The NSTR non-AP MLD3 second radio 524 is connected to NSTR non-AP MLD3 second antenna 528. This allows for MLO. Further, NSTR non-AP MLD3 520 includes STR non-AP MLD2 first radio 532 and STR non-AP MLD2 second radio 534. The STR non-AP MLD2 first radio 532 is connected to STR non-AP MLD2 first antenna 536. The STR non-AP MLD2 second radio 534 is connected to STR non-AP MLD2 second antenna 538. This allows for MLO.

When the primary link is idle, the STR/NSTR non-AP MLD (520 and 530) and EMLSR AP MLD 502 uses its primary link (540 or 546) to do the frame exchanges. When the primary link is busy, the STR/NSTR non-AP MLD (520 or 530) uses the non-primary link (542 or 544) to do frame exchanges with the EMLSR AP MLD 502. The frame exchanges in a non-primary link ends at the end of the TXOP owned by the neighbor BSS in the primary link.

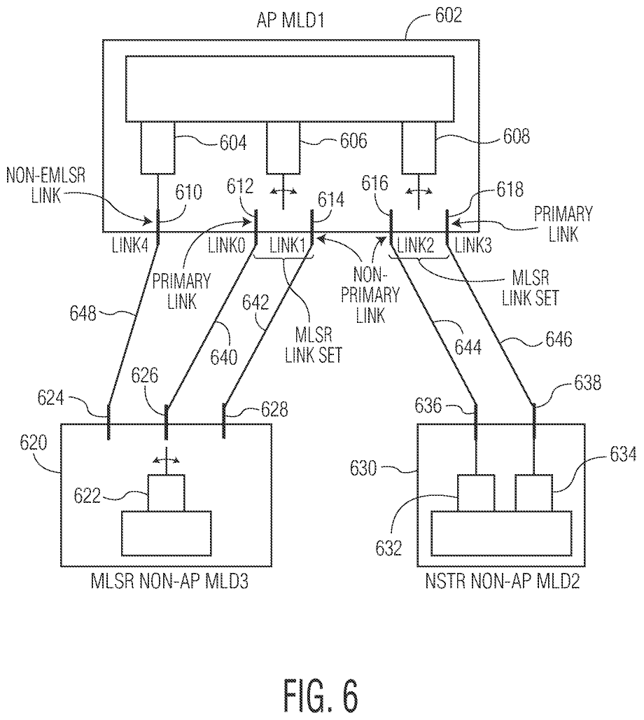

A sixth proposal describes a frame exchange with a MLSR AP MLD. FIG. 6 illustrates a system with a MLSR AP MLD and a NSTR non-AP MLD and MLSR non-AP MLD. The MSLR AP MLD1 602 includes MSLR AP MLD1 first radio 604, MSLR AP MLD1 second radio 606, and MSLR AP MLD1 third radio 608. The MSLR AP MLD1 first radio 604 is connected to MSLR AP MLD1 first antenna 610. The MSLR AP MLD1 second radio 606 is connected to MSLR AP MLD1 second antenna 612 and MSLR AP MLD1 third antenna 614. The MSLR AP MLD1 third radio 608 is connected to MSLR AP MLD1 fourth antenna 616 and MSLR AP MLD1 fifth antenna 618. The MSLR AP MLD1 602 communicates with MLSR non-AP MLD3 620 and NSTR non-AP MLD2 630. The MSLR AP MLD1 602 has a fifth link 648 that is a non-EMLSR link connected to the MLSR non-AP MLD3 620. The MSLR AP MLD1 602 has a first link 640 and second link 642 with the MLSR non-AP MLD3 620. The first link 640 and second link 642 form an MLSR link set. The MSLR AP MLD1 602 has third link 644 and fourth link 646 with NSTR non-AP MLD3 first radio 632. The third link 644 and fourth link 646 form an MLSR link set. The first link 640 and fourth link 646 are primary links. The second link 642 and third link 644 are secondary links.

The MLSR non-AP MLD3 620 includes a MLSR non-AP MLD3 radio 622. The MLSR non-AP MLD3 radio 622 is connected to MLSR non-AP MLD3 first antenna 624, MLSR non-AP MLD3 second antenna 626, AND MLSR non-AP MLD3 third antenna 628. This allows for MLO. Further, NSTR non-AP MLD2 630 includes NSTR non-AP MLD2 first radio 632 and NSTR non-AP MLD2 second radio 634. The NSTR non-AP MLD2 first radio 632 is connected to NSTR non-AP MLD2 first antenna 636. The NSTR non-AP MLD2 second radio 634 is connected to NSTR non-AP MLD2 second antenna 638. This allows for MLO.

It is noted that in 802.11be, a MLSR non-AP MLD 602 can switch its radio to different link on a TXOP basis. A MLSR AP MLD 602 can define primary link and non-primary link as a MLSR link set. The primary link is used to do the frame exchanges, Beaconing, and association. When the primary link is busy because of neighbor BSS's TXOP, the MLSR AP MLD 602 switches its radio to non-primary link for the frame exchanges. The non-primary link's frame exchanges will end at the end of the neighbor BSS's TXOP in primary link and the MLSR AP MLD 602 switches its radio to the primary link at the end of the neighbor BSS's TXOP in primary link. A MLSR AP MLD 602 may have a low cost radio to monitor one link when doing frame exchanges in another link.

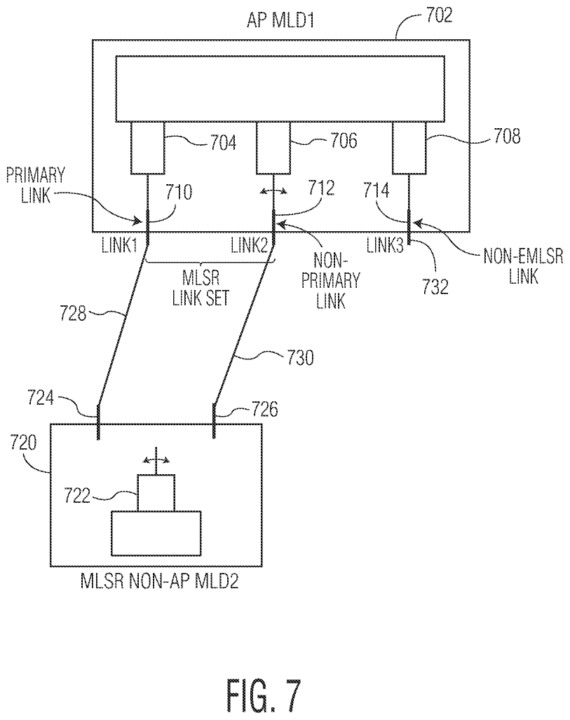

In a seventh proposal a STR AP MLD exchanges frames with a MLSR non-AP MLD. FIG. 7 illustrates a system with a STR AP MLD and a MLSR non-AP MLD. The STR AP MLD1 702 includes STR AP MLD1 first radio 704, STR AP MLD1 second radio 706, and S AP MLD1 third radio 708. The STR AP MLD1 first radio 704 is connected to STR AP MLD1 first antenna 710. The STR AP MLD1 second radio 706 is connected to STR AP MLD1 second antenna 712. The STR AP MLD1 third radio 708 is connected to STR AP MLD1 third antenna 714. The STR AP MLD1 702 communicates with MLSR non-AP MLD2 720. The third link 732 is a non-EMLS link. The STR AP MLD1 702 has first link 728 and second link 730 with the//720. The first link 728 and second link 730 form an MLSR link set. The first link 728 is a primary link. The second link 730 is a secondary link.

The MLSR non-AP MLD2 720 includes a MLSR non-AP MLD2 radio 722. The MLSR non-AP MLD2 radio 722 is connected to MLSR non-AP MLD2 first antenna 724 and MLSR non-AP MLD2 radio 722. This allows for MLO.

It is noted that in 802.11be, a MLSR non-AP MLD 720 can switch its radio to different link on TXOP basis. A STR AP MLD 702 can define primary link (728) and non-primary link (730) as a MLSR link set for MLSR non-AP MLD operation. Both the primary link and non-primary link in this case are used to do the frame exchanges, Beaconing, and association. When the primary link is busy because of neighbor BSS's TXOP, the MLSR AP MLD 720 switches its radio to non-primary link for the frame exchanges. The non-primary link's frame exchanges will end at the end of the neighbor BSS's TXOP in primary link and the MLSR AP MLD 720 switches its radio to the primary link at the end of the neighbor BSS's TXOP in primary link. A MLSR AP MLD 720 may have a low cost radio to monitor one link when doing frame exchanges in another link.

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Unless otherwise indicated, all numbers expressing parameter values and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of exchanging frames between a first multi-link device (MLD) and a second MLD, comprising:
announcing, by the first MLD, a set of links with the second MLD, wherein the set of links includes a primary link and a non-primary link and wherein a single first radio in the first MLD switches between the primary link and the non-primary link;
switching, by the first MLD and second MLD, to the non-primary link when the primary link is busy;
exchanging frames between the first MLD and the second MLD; and
switching back to the primary link, by the first MLD and the second MLD, when a transmit opportunity (TXOP) of the primary link ends.

2. The method of claim 1, wherein the first MLD is multi-link single radio (MLSR) AP MLD and the second MLD is one of a MLSR MLD, enhanced MLSR (EMLSR) MLD, a simultaneous transmit and receive (STR) multi-link multiple radio (MLMR), and a non-STR (NSTR) MLMR non-AP MLD.

3. The method of claim 2, wherein the first MLD includes a second radio to monitor one link when doing frame exchanges in another link.

4. The method of claim 1, wherein the first MLD is a non-simultaneous transmit and receive (NSTR) multi-link multiple radio (MLMR) AP MLD and the second MLD is one of a multi-link single radio (MLSR) MLD, enhanced MLSR (EMLSR) MLD, a simultaneous transmit and receive (STR) MLMR, and a non-STR (NSTR) MLMR non-AP MLD.

5. The method of claim 1, wherein the first MLD is an enhanced multi-link single radio (EMLSR) AP MLD and the second MLD is one of a MLSR MLD, enhanced MLSR (EMLSR) MLD, a simultaneous transmit and receive (STR) multi-link multiple radio (MLMR), and a non-STR (NSTR) MLMR non-AP MLD.

6. The method of claim 5, wherein the set of links is an EMLSR link set.

7. The method of claim 5, wherein the first MLD switches to monitor multiple links when a frame exchange failure is detected or when the first MLD receives a frame not addressed to the first MLD.

8. The method of claim 5, wherein the first MLD operates in the non-primary link when a frame exchange failure is detected or when the first MLD receives a frame not addressed to the first MLD.

9. The method of claim 1, wherein the first MLD and the second MLD are multi-link tunneled direct-link setup (TDLS) peer multi-link single radio (MLSR) non-AP MLDs.

10. A first multi-link device (MLD) for communicating with a second MLD, comprising a processor configured to:
announce a set of links with the second MLD, wherein the set of links includes a primary link and a non-primary link and wherein a single first radio in the first MLD switches between the primary link and the non-primary link;
switching to the non-primary link when the primary link is busy;
exchanging frames between the first MLD and the second MLD; and
switching back to the primary link, by the first MLD when a transmit opportunity (TXOP) of the primary link ends.

11. The first MLD of claim 10, wherein the first MLD is a multi-link single radio (MLSR) AP MLD and the second MLD is one of a MLSR MLD, enhanced MLSR (EMLSR) MLD, a simultaneous transmit and receive (STR) multi-link multiple radio (MLMR), and a non-STR (NSTR) MLMR non-AP MLD.

12. The first MLD of claim 11, wherein the first MLD includes a second radio to monitor one link when doing frame exchanges in another link.

13. The first MLD of claim 10, wherein the first MLD is a non-simultaneous transmit and receive (NSTR) multi-link multiple radio (MLMR) AP MLD and the second MLD is one of a multi-link single radio (MLSR) MLD, enhanced MLSR (EMLSR) MLD, a simultaneous transmit and receive (STR) MLMR, and a non-STR (NSTR) MLMR non-AP MLD.

14. The first MLD of claim 10, wherein the first MLD is an enhanced multi-link single radio (EMLSR) AP MLD and the second MLD is one of a MLSR MLD, enhanced MLSR (EMLSR) MLD, a simultaneous transmit and receive (STR) multi-link multiple radio (MLMR), and a non-STR (NSTR) MLMR non-AP MLD.

15. The first MLD of claim 14, wherein the set of links is an EMLSR link set.

16. The first MLD of claim 14, wherein the first MLD switches to monitor multiple links when a frame exchange failure is detected or when the first MLD receives a frame not addressed to the first MLD.

17. The first MLD of claim 14, wherein the first MLD stays in the non-primary link when a frame exchange failure is detected or when the first MLD receives a frame not addressed to the first MLD.

18. The first MLD of claim 10, wherein the first MLD and the second MLD are multi-link tunneled direct-link setup (TDLS) peer multi-link single radio (MLSR) non-AP MLDs.
